(19) United States
(12) Patent Application Publication
(10) Pub. No.: US 2008/0018591 A1
(43) Pub. Date: Jan. 24, 2008

(54) User Interfacing

(76) Inventors: Arkady Pittel, Brookline, MA (US); Andrew M. Goldman, Stow, MA (US); Ilya Pittel, Brookline, MA (US); Sergey Liberman, Bedford, MA (US); Stanislav V. Elektrov, Needham, MA (US)

Correspondence Address: FISH & RICHARDSON PC, P.O. BOX 1022, MINNEAPOLIS, MN, 55440-1022, US

(21) Appl. No.: 11/490,736

(22) Filed: Jul. 20, 2006

(51) Int. Cl. G09G 5/00

(52) U.S. Cl. 345/156

(57) ABSTRACT

A display is projected, information representing an image of the projected display and at least a portion of a pointing device in a vicinity of the projected display is optically captured, and the display is updated based on the captured image information.

### BACKGROUND

This description relates to user interfacing.

Handwriting recognition is sometimes used, for example, for text input without a keyboard, as described in pending U.S. patent application Ser. No. 09/832,340, filed Apr. 10, 2001, assigned to the assignee of this application and incorporated here by reference. Published U.S. Patent application 2006/0077188, titled “Device and method for inputting characters or drawings in a mobile terminal using a virtual screen,” proposes combining projection of a display from a handheld device with handwriting recognition.

### SUMMARY

In general, in one aspect, a display is projected, information representing an image of the projected display and at least a portion of a pointing device in a vicinity of the projected display is optically captured, and the display is updated based on the captured image information.

Implementations may include one or more of the following features.

The pointing device includes a finger. The pointing device includes a stylus. The image of the pointing device includes information about whether the pointing device is activated. The image of the portion of the pointing device includes light emitted by the pointing device. Light is emitted from the pointing device in response to light from the projector. The light is emitted from the pointing device asynchronously with the light emitted by the projector. The image of the pointing device is captured when the pointing device is emitting light and the image of the display is captured when the projector is emitting light. Visible light is blocked and infrared light is transmitted. The image of the portion of the pointing device includes light reflected by the pointing device. The pointing device is illuminated. The display is projected and the pointing device is illuminated in alternating frames. Light is directed into an ellipse around a previous location of the pointing device, and the ellipse is enlarged until the captured image includes light reflected by the pointing device. Illuminating the pointing device comprises energizing a light source when a signal indicates that the pointing device is in use.

Projecting the display includes reflecting light with a micromirror device. Projecting the display includes reflecting infrared light. Projecting the display includes projecting an image with a first subset of micromirrors of the micromirror device and directing light in a common direction with a second subset of micromirrors of the micromirror device. The first subset of micromirrors reflect visible light, and the second subset reflect infrared light. Capturing information representing an image of at least a portion the pointing device includes capturing movement of the pointing device. The movement of the pointing device includes handwriting. Updating the display includes one or more of creating, modifying, moving, or deleting a user interface element based on movement of the pointing device, editing text in an interface element based on movement of the pointing device, and drawing lines based on movement of the pointing device. The display is projected within a field of view, and updating the display includes changing the field of view based on movement of the pointing device.

The movement of the pointing device is interpreted as selection of a hyperlink in the display, and the display is updated to display information corresponding to the hyperlink. The movement of the pointing device is interpreted as an identification of another device, and a communication is initiated with the other device based on the identification. Initiating the communication includes placing a telephone call. Initiating the communication includes assembling handwriting into a text message and transmitting the text message. Initiating the communication includes assembling handwriting into an email message and transmitting the email message.

Projecting a display includes projecting an output image and projecting an image of a set of user interface elements, and capturing the image information includes identifying which projected user interface elements the pointing device is in the vicinity of. The image of a set of user interface elements includes an image of a keyboard. updating the display includes adjusting the shape of the display to compensate for distortion found in the captured image of the display. Updating the display includes repeatedly determining an angle to a surface based on the captured information representing an image of the display, and adjusting the shape of the display based on the angle. Projecting the display includes projecting reference marks and determining an angle includes determining distortion of the reference marks. Updating the display includes adjusting the display to appear undistorted when projected at a known angle. The known angle is based on an angle between a projecting element and a base surface of a device housing the projecting element. Projecting the display includes altering a shape of the projected display based on calibration parameters stored in a memory.

An image of a surface is captured. A file system object representing the image of the surface is created. The image of the surface is recognized as a photograph, and in which the file system object is an image file representing the photograph. The image of the surface is recognized as an image of a writing, and the file system object is a text file representing the writing. Information representing movement of the pointing device is captured, and a file system object is edited based on to movement of the pointing device. Editing includes adding, deleting, moving, or modifying text. Editing includes adding, deleting, moving, or modifying graphical elements. Editing includes adding a signature.

The display includes a computer screen bitmap image. The display includes a vector-graphical image. The vector-graphical image is monochrome. The vector-graphical image includes multiple colors. Projecting the display includes reflecting light along a sequence of line segments using at least a subset of micromirrors of a micromirror device. The display is generated by removing content from an image, and projecting the display includes projecting the remaining content. Removing content from an image includes removing image elements composed of bitmaps. Projecting the display includes projecting a representation of items each having unique coordinates, a location touched by the pointing device is detected and correlated to at least one of the projected items. The captured information representing images is transmitted to a server, a portion of an updated display is received from the server, and updating the display includes adding the received portions of an updated display to the projected display.

In general, in one aspect a processor is programmed to receive input from a camera including an image of a projected interface and a pointing device, generate an interface based on the input, and use a projector to project the interface. In some examples, the projector and the camera can be repositioned relative to the rest of the apparatus. In some examples, wireless communication circuitry is included.

In general, in one aspect a projector has a first field of view, a camera has a second field of view, the first and second fields of view not overlapping, and a processor programmed to receive input from the camera including an image of a projected interface and a pointing device, generate an interface based on the input, and use the projector to project the interface.

In general, in one aspect, a cone-shaped filter is positioned in a path of light from a light source.

Other features and advantages will be apparent from the description and the claims.

### DESCRIPTION OF DRAWINGS

FIGS. 1, 6A-6C, 8, 9 10A-D, 11A-B, 12A-D, 13, and 15A-B are isometric views of a portable device.

FIGS. 2, 3A, 3B and 4 are schematic views of projectors.

FIG. 5 is an isometric view of a detail of a portable device.

FIGS. 7A and 7B are schematic views of a projection.

FIG. 14 is a schematic perspective view of a detail of a projector.

FIGS. 15C-D are schematic plan views of details of a portable device.

FIGS. 16A-C are schematic side views of a stylus.

FIG. 16D is a schematic depiction of using a finger as an input.

FIG. 16E is a schematic cross-section side view of a stylus.

FIG. 17 is an example of a projection.

### DETAILED DESCRIPTION

Cellular phones, although small, would be able to supplant larger mobile computers even more widely if the constraints associated with their small displays and interface constraints were resolved.

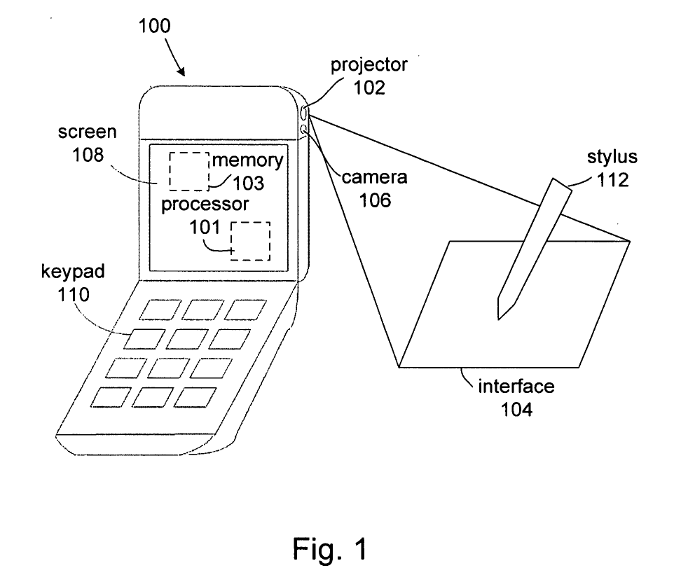

By integrating, in a small hand-held device, a small projector, a camera, and a processor to interpret inputs by an operator on a virtual projected display, it is possible to provide a display and input system that is always available and as usable as full-sized displays and input devices on larger systems. As shown in FIG. 1, such a device 100 with a processor 101 and memory 103 uses a small image projector 102 to display a user interface 104 and a small camera 106 both to assure the quality of the displayed interface and to receive input from the user. The device 100 may also have a built-in screen 108 and keypad 110 or other input mechanism, as in the specific example of a traditional cell-phone interface illustrated. The projector and camera could also be integrated into a wide variety of other hand-held or portable or wireless devices, including personal digital assistants, music players, digital cameras, and telephones.

The camera 106 may be a thirty-frames-per-second or higher-speed camera of the kind that has become a commodity in digital photography and cellular phones. Using such a camera, any computing device of any size can be provided with a virtual touch screen display. The need for a physical hardware display monitor, a keyboard, a mouse, a joystick, or a touch pad may be eliminated.

The operator of the device 10 can enter data and control information by touching the projected interface 104 using passive (light-reflecting) or active (light emitting) objects such as fingers or pens. A finger, a pen, a stylus 112, or any other appropriately sized object can be used by the operator to serve as an electronic mouse (or other cursor control or input device) on such a virtual display, replacing a regular mouse. We sometimes refer to the input device, in the broadest sense, as a writing instrument or pointing device. The use of the writing instrument to provide handwriting and other input and the use of recognition processes applied to the input as imaged by the camera 106 can replace digitizing pads currently used in tablet PCs and PDAs. Traditional keyboard functions are made available by projecting a keyboard image on the virtual display 104 and using the camera to detect which projected keys the user touches with a light emitting or reflecting object such as a finger, pen, or stylus. Techniques for detecting the position of such an input device are described in U.S. Pat. No. 6,577,299, issued to the assignee of the current application and incorporated here by reference. The ability of a single device 100 to project a display, detect user interaction with the display, and respond to that interaction, all without any physical contact, provide significant advantages.

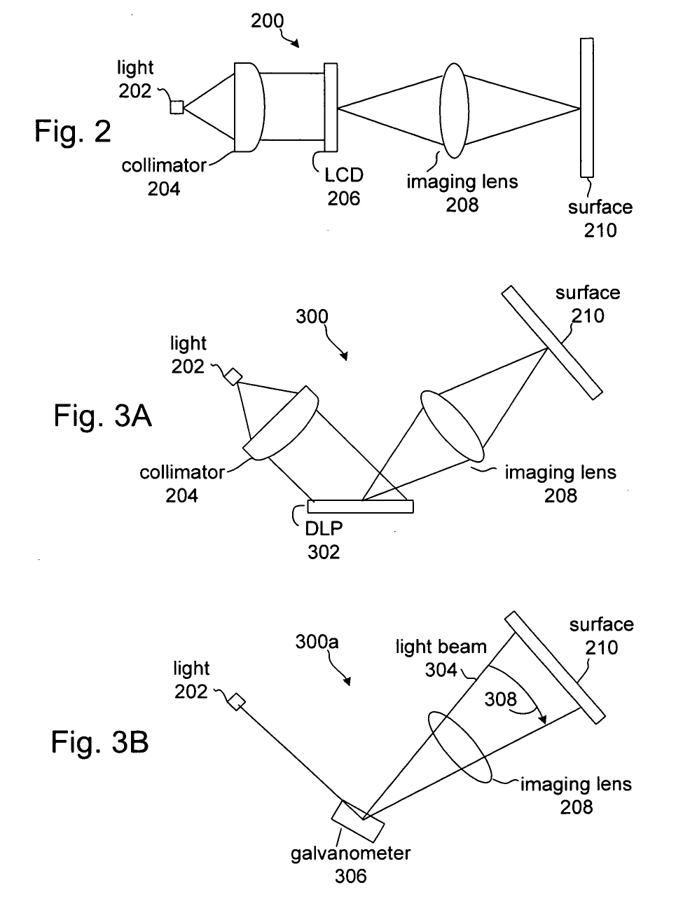

As shown in FIG. 2, a transmissive black and white projector 200 includes a single light source 202, a collimator 204, a transmissive imaging device 206, and an imaging lens 208. The collimator 204 shapes the light from the source 202 into a collimated beam which then passes through the transmissive imaging device 206, for example a liquid crystal display. The imaging device is configured to create the projected image in the light that passes through it by blocking light in some locations and transmitting it in others. The transmissive imaging device 206 could be black and white, or could block and transmit less than all of the light, creating shades of grey in the projected image. After the image is imparted to the light, the imaging lens 208 directs and focuses the light onto a projection surface 210. The projection surface could be a screen designed for the purpose, or could be any relatively flat surface.

In FIG. 3A, a reflective black and white projector 300 is similar to the transmissive projector 200 of FIG. 2, but instead of blocking or transmitting light that passes through it, the reflective imaging device 302 reflects light at locations to be displayed and absorbs or scatters light at locations that are to be dark. The amount of reflection or absorption determines the brightness of the light at any given location. In some examples, the reflective imaging device 302 is a micro-mirror array (DLP) or a Liquid Crystal on Silicon (LCoS) array. The light source 202, collimator 204, and imaging lens 208 operate in the same manner as in the transmissive projector.

In some implementations, the light source is a laser, and rather than being expanded to illuminate the entire imaging area, the beam is scanned line-by-line to form the projected image. Alternatively, instead of scanning and projecting a collection of points, a beam can be directly moved in a pattern of lines to represent the desired image. For example, as shown in FIG. 3B, a projector 300a uses a galvanometer 306 to form the image, sweeping (arrow 308) a light beam 304 along a sequence of lines and curves to form an image in a vector-based mode.

As discussed below, the technique of directing the beam to specific coordinates on the projected surface can be used to illuminate the writing instrument with infrared light to be reflected back for its position detection.

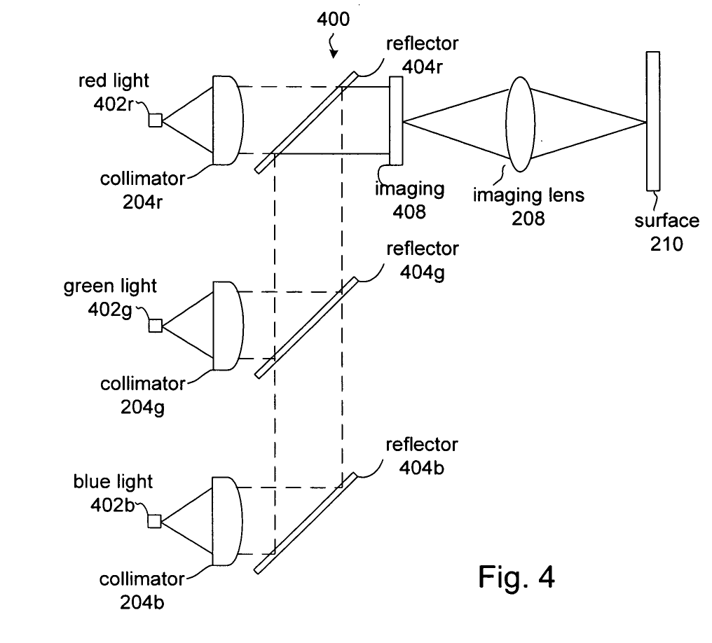

There are many ways to construct a color projector, one of which is shown in FIG. 4. Most significantly, three colors, usually red, green, and blue, are necessary to project images with a full range of colors. In one example, a projector 400 has individual red, green, and blue light sources 402r, g, and b that direct light through individual collimators 204r, g, and b and onto reflectors 404r, g, and b, that direct all three collimated beams onto or through an imaging device 408. The imaging device could be transmissive, as device 206, or reflective, as device 306 (FIGS. 2 and 3, respectively). The light sources are illuminated sequentially, and the imaging device 408 changes as needed for the different colors. The imaged light is focused by the imaging lens 208 onto the projection surface 210 as before. As long as the projector switches between the three sources at a sufficient rate, a human observer will perceive a single, full-color image rather than a sequence of single-color images. Alternatively, each color of light can have its own imaging device, and the three differently-colored images projected simultaneously to form a composite, full-color image. In another example, there could be a single white light source with color imparted to the image by the imaging device or with filters.

Small, compact projectors are currently available from companies such as Mitsubishi Electric of Irvine, Calif. Projectors suitable for inclusion in portable computing devices have been announced by a number of sources, including Upstream Engineering of Encinitas, Calif., and Light Blue Optics, of Cambridge, UK. A suitable projector is able to project real-time images from a processor on a cellular phone or other small mobile platform onto any surface at which it is aimed, allowing for variable size and display orientation. If a user is showing something to others, such as a business presentation, a vertical surface such as a wall may be the most suitable location for the projection. On the other hand, if the user is interacting with the device using its handwriting recognition capability or just working as he would with a tablet PC, he may prefer a horizontal surface. Depending upon the brightness of the projector and the focal length and quality of its optics, a user may be able to project the interface over a wide range of sizes, from a small private display up to a large, wall-filling movie screen.

The information that is projected onto the display surface can be of any kind (and other kinds) and presented in any way (and other ways) that such information is presented on typical displays of devices.

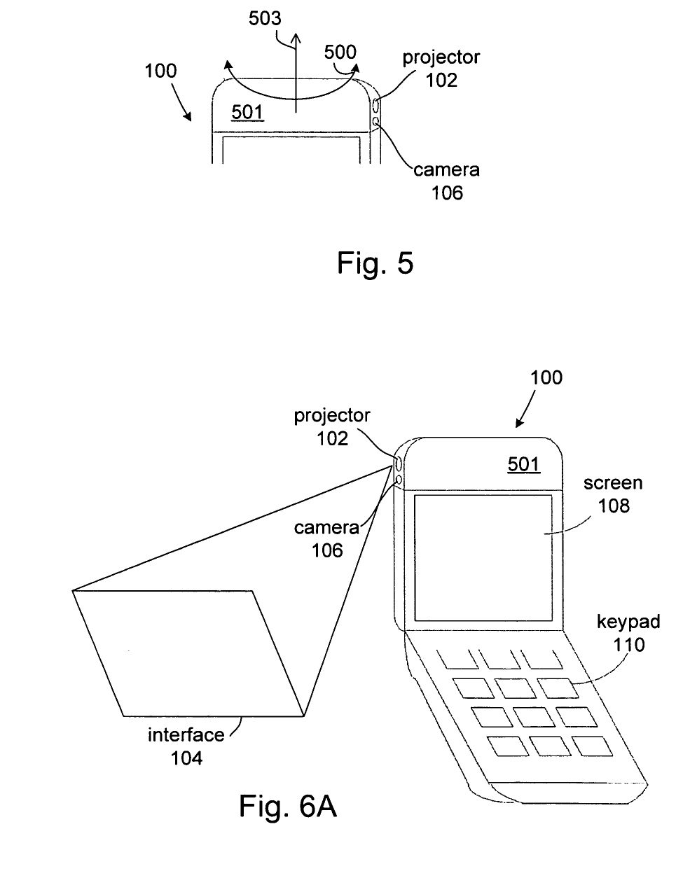

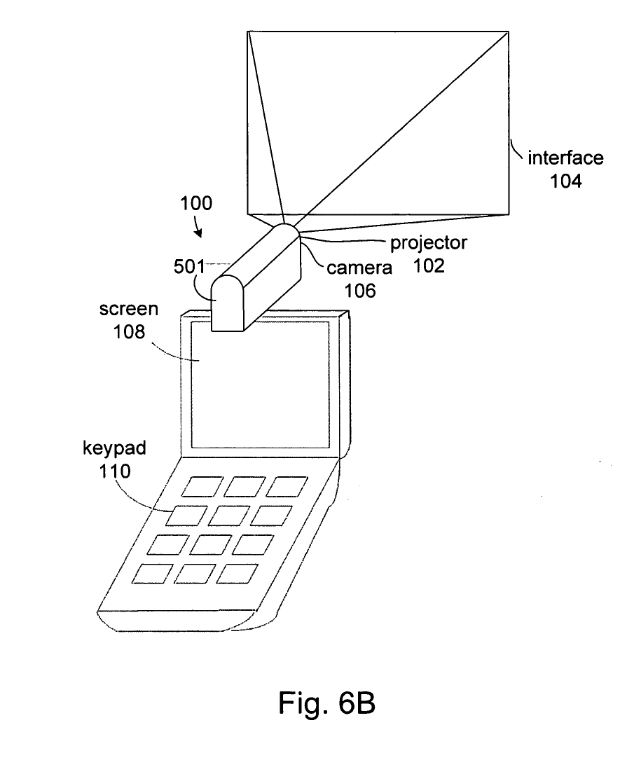

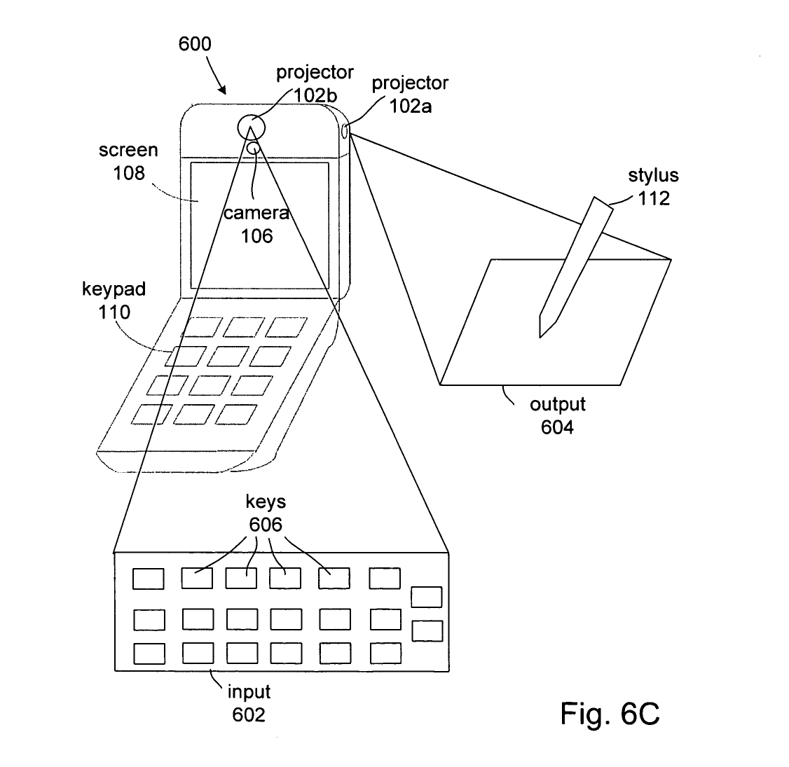

As shown in FIG. 1 a projector 102 and camera 106 are aligned to provide a virtual display 104 and user control of a computer. In some examples, as shown in FIGS. 5, 6A, and 6B, a module 501 containing the projector 102 and camera 106 can be rotated 360 degrees around an axis 503, as shown by arrow 500, so that it can accommodate right- and left-handed users by positioning the display 104 on the right (FIG. 1) or on the left (FIG. 6A) of the portable device. The module can also be positioned in any number of other positions around its vertical rotation axis. For example, a user may decide to position the projector and camera module to project on a vertical surface as shown in FIG. 6B.

In some implementations, as shown in FIG. 6C, a module 600 with two projectors 102a and 102b is used, one to project a display 604 and the other to project an input area, such as a keyboard 602, thus spatially separating the input and output functions, as discussed in more detail below. While the display 604 is projected to the right or left of the device 100, the keyboard 602 is projected in front. Two cameras can be used, so that both projections can be used for input.

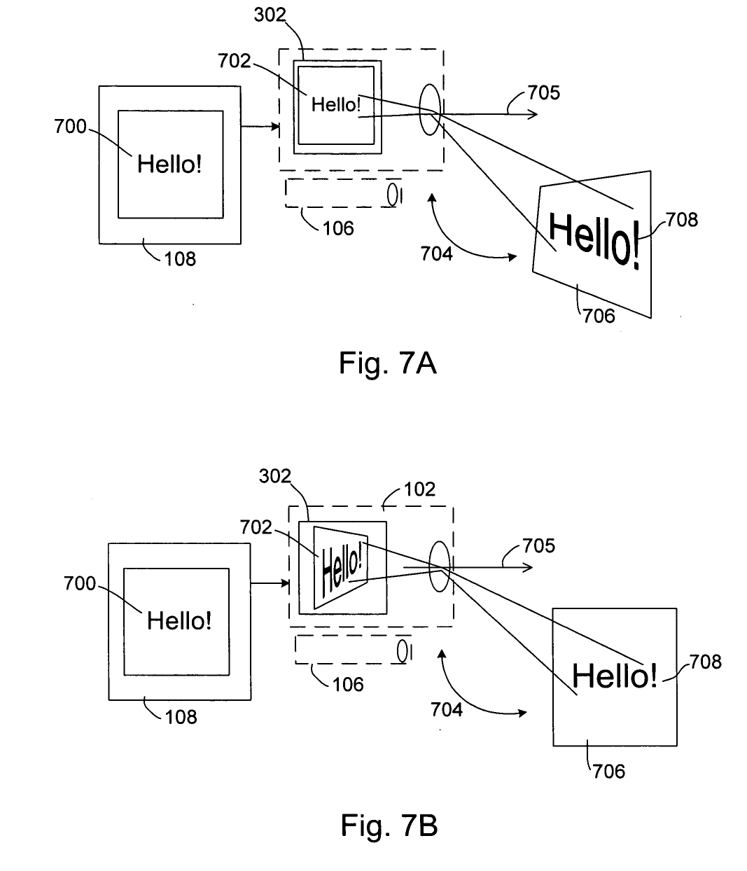

As shown in FIGS. 7A and 7B, the camera 106 can be used to detect distortion in the projected image 708, that is, differences between a projected image 708 and a corresponding image 700 displayed on the screen 108 of the portable device. Such distortions may occur, for example, due to the angle 704 between a projection axis 705 of the projector 102 and the display surface 706. By modifying the image 702 formed by the imaging device 302 to compensate whatever distortions result from angle 704 being other than 90 degrees, the image 708 reflected on the display surface 706 will be corrected and match more closely the image 700 that is intended, as shown in FIG. 7B. The camera 106 can detect, and the processor compensate for, other distortions as well, for example, due to non-linearities in the optical system of the camera, a color of the projection surface or ambient light, or motion of the projection surface.

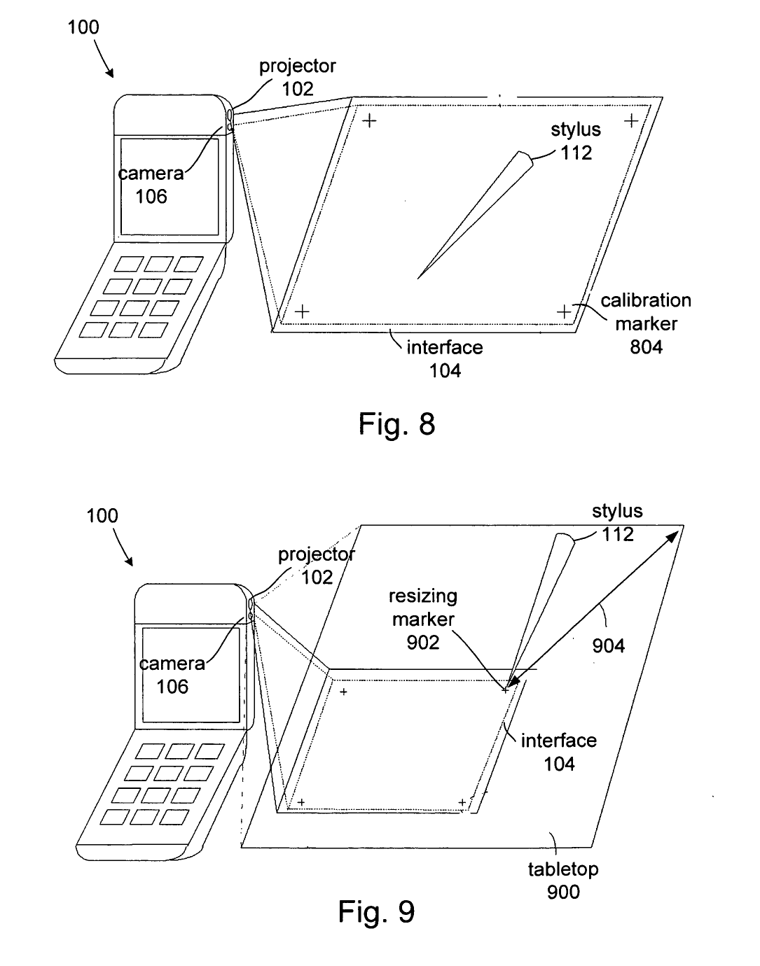

In some examples, as shown in FIG. 8, to facilitate detecting and correcting for any distortion, the projected interface 104 may include calibration markers 804. The camera 106 detects the positions and deformations of the markers 804 and the processor uses that information to correct the projected interface 104 as discussed with regard to FIG. 7B.

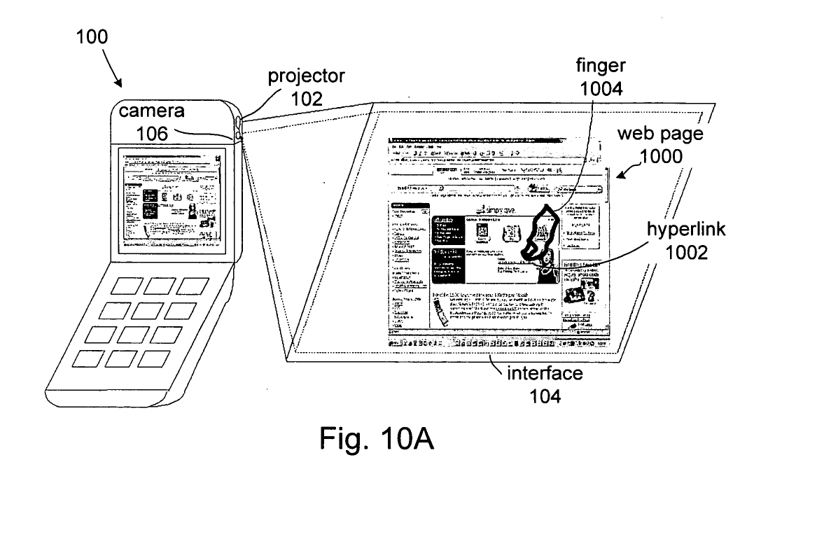

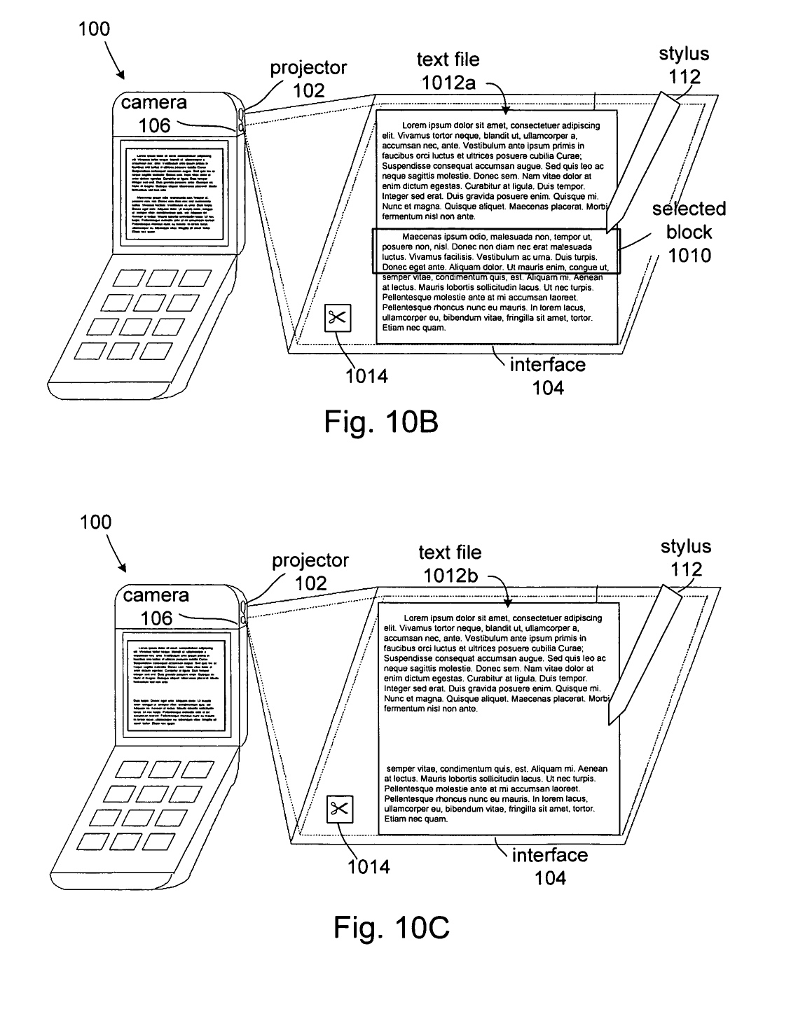

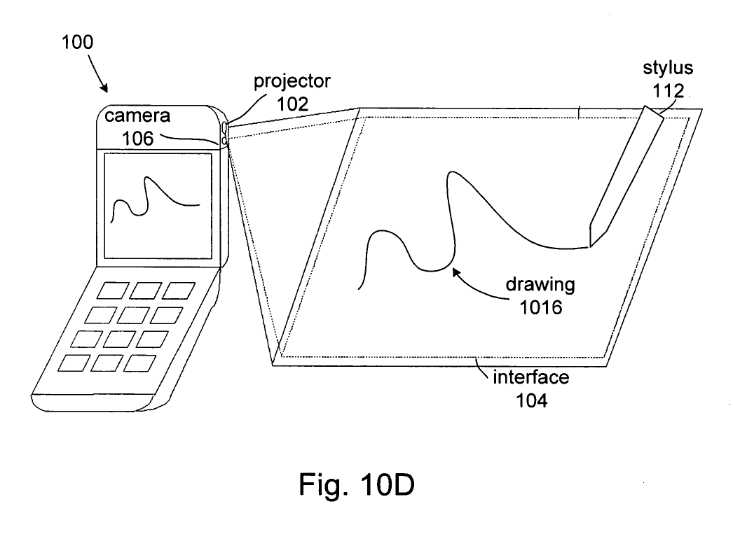

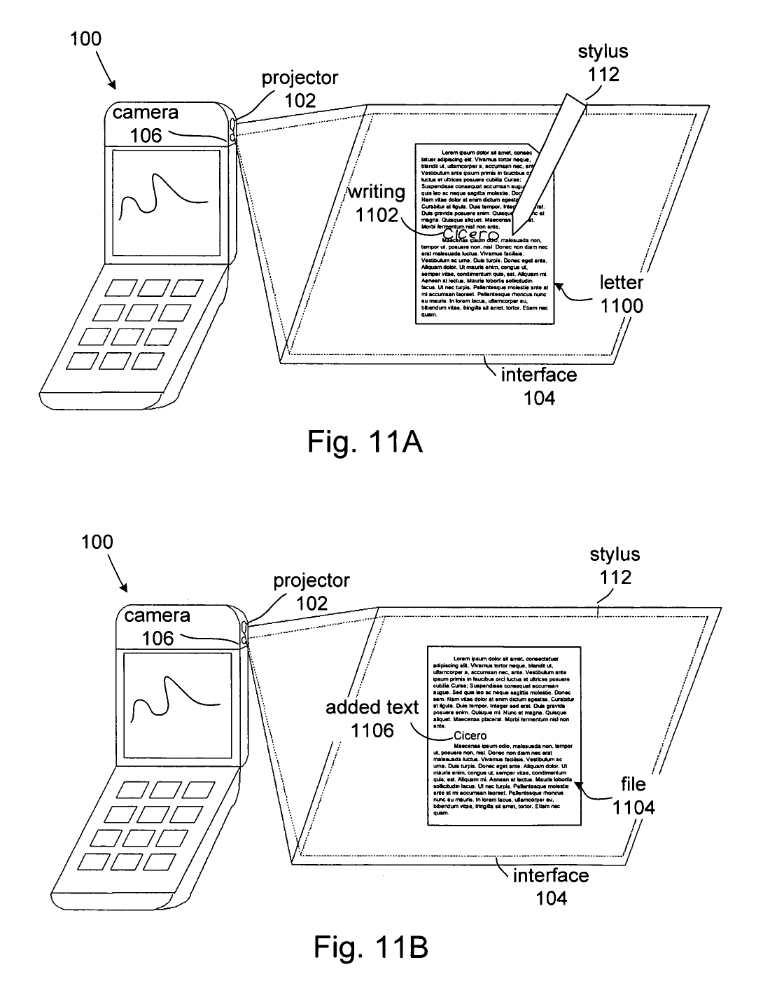

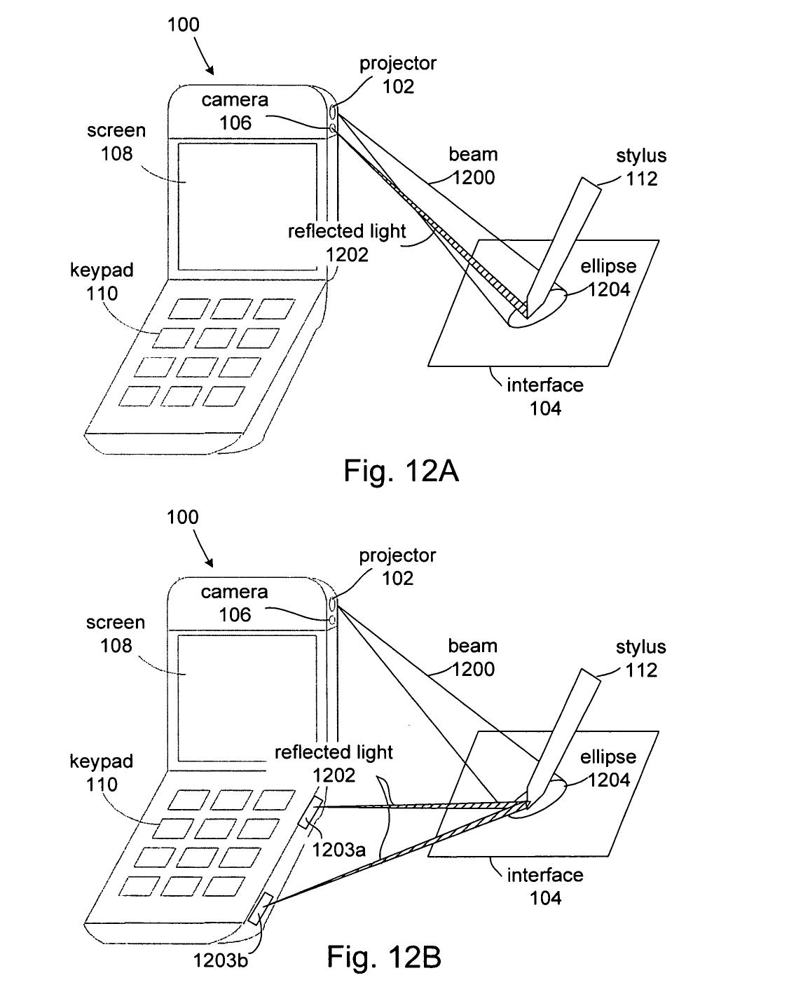

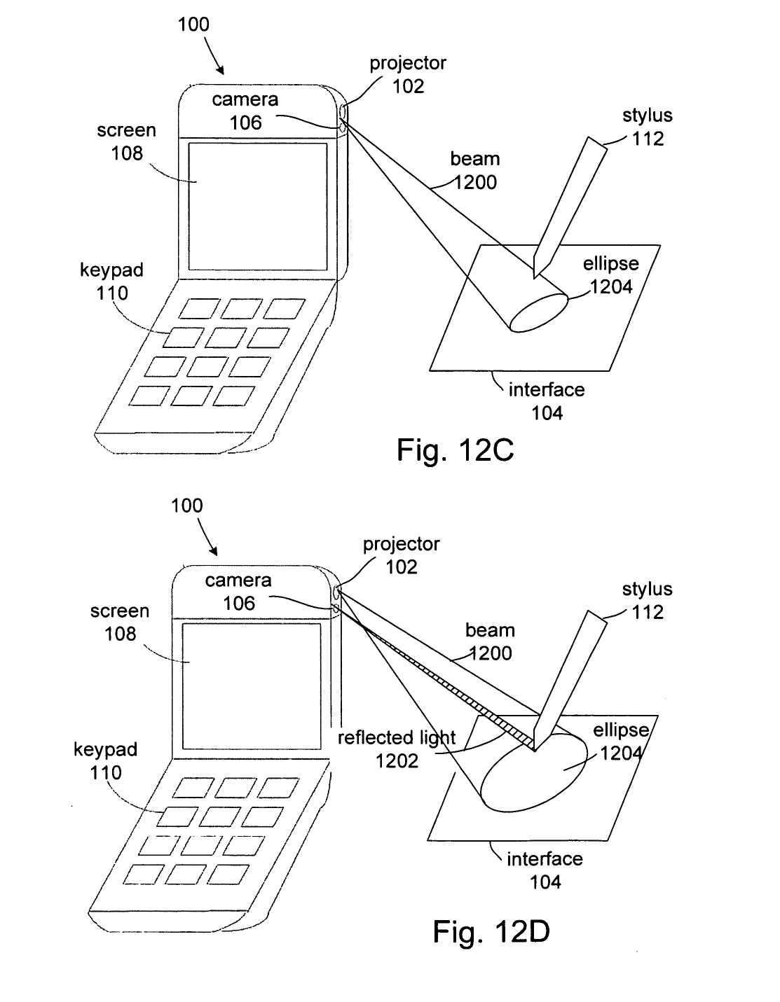

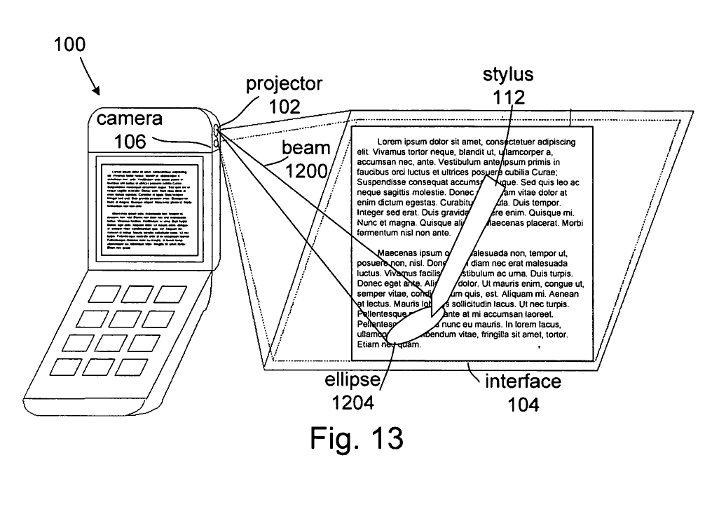

In some examples, the device 100 is positioned so that the display 104 will be projected onto a nearby surface, for example, a tabletop, as shown on FIG. 9. The projected display 104 can have various sizes controlled by hardware or software on the portable device 100. A user could instruct the device to display a particular size using the stylus 112, by dragging a marker 902 as shown by arrow 904. The camera 106 detects the position and movement of the stylus 112 and reports that information to a processor in the device 100, which directs the projector to adjust the projected image accordingly. The user could also adjust the aspect ratio of the display in a similar manner. Thus, in general, the projector, camera, and processor can cooperate to enable the manner, size, shape, configuration, and other aspects of the projection on the display surface to be controlled either automatically or based on user input.

A projector as described is capable of projecting images regardless of their source, for example, they could be typed text, a spreadsheet, a movie, or a web page. As a substitute for the traditional user interface of a pen-based computer, the camera can be used to observe what the user does with a pointing device, such as a stylus or finger, and the user can interact with the displayed image by moving the pointing device over the projection. Based on this input, the portable device's processor can update its user interface and modify the projected image accordingly. For example, as shown in FIG. 10A, if the user's finger 1004 touches a hyperlink 1002 on a displayed web page 1000, the processor would load that link and update the display 104 to show the linked page. Similarly, as shown in FIGS. 10B and 10C, if the user used the stylus 112 to select a block of text 1010 in a projected text file 1012a and then touched a projected “cut” button 1014, that text would be removed from the displayed text 1012b. As an alternative to including buttons in the projected interface, the stylus could be used to draw a symbol for the desired command, for example, a circle with a line through it to indicate delete. In general, the information that is displayed by the projector could be modified from the images displayed on a more conventional desktop display to accommodate and take advantage of the way a user would and could make use of the projected interface.

Alternatively, hardware keys on the device keyboard can be used for this or any other functions.

The processor could also be configured to add, to the projected image, lines 1016 representing the motion of the stylus, so that the user can “draw” on the image and see what he is doing, as if using a real pen to draw on a screen, as shown in FIG. 10D. If the drawing has meaning in the context of the displayed user interface, the processor can react accordingly, for example, by interpreting the drawn lines as handwriting and converting them to text or to the intended form (circle, triangle, square, etc), or add other formatting features: bullets, numbering, tabs, etc. Of course, displaying the lines is not necessary for such a function, if the user is able to write sufficiently legibly without visual feedback.

In some examples, in addition to displaying a pre-determined user interface, the camera can be used to capture preprinted text or any other image. Together with handwriting input on top of the captured text, this can be used for text editing, electronic signatures, etc. In other words, any new content can be input into the computer. For example, as shown in FIG. 11A, if the user wants to edit a letter, but only has a printed copy, he could place the letter 1100 in the displayed image area and then “write” on it with the stylus 112. The display will show the writing 1102, to provide feedback to the user. The processor, upon receiving the images of the letter 1100 and the writing 1102 from the camera 106, will interpret both and combine them into a new text file, forming a digital version 1104 of the letter, updated to include added text 1106 based on the writing 1102, as shown in FIG. 11B. Commands can be distinguished from input text by, for example, drawing a circle around them. This will enable a user to bring preexisting content into a digital format for post-processing.

There are a wide variety of ways that the input of the pointing device can be detected. A stylus may have a light emitting component in either a visual or invisible spectrum, including infrared, provided the camera can detect it, as described in pending U.S. patent application Ser. No. 10/623,284, filed Jul. 17, 2003, assigned to the assignee of the present application and incorporated here by reference. Alternatively, two or more linear optical (CMOS) sensors can be used to detect light from the pointing device 112 as described in U.S. patent application Ser. No. 11/418,987, titled Efficiently Focusing Light, filed May 4, 2006, also assigned to the assignee of the present application and incorporated here by reference. In addition to light emitting input devices, it is possible to use the projector light and a reflective stylus, pen, or other pointing device, such as a finger. In some examples, as shown in FIG. 12A, the projector is configured to focus a relatively narrow beam 1200 towards the location of the pointing device 112. The light beam 1200 is reflected off the pointing device 112 back to the aligned camera 106. (The reflected light 1202 is reflected in multiple directions. Only the light reaching the camera 106 is shown in the figure.) The coordinates of the origin of the reflected light 1202 are calculated, for example, as described in the above-referenced Efficiently Focusing Light patent application, to find the position of the pointing device 112 in the display area and to continue aiming the illumination beam 1200 on the pointing device 112 as it is moved. An example using two linear array sensors is shown in FIG. 12B. Sensors 1203a, b each detect the angle of reflected light 1202, which is used to triangulate the location of the pointing device 112 in the interface 104.

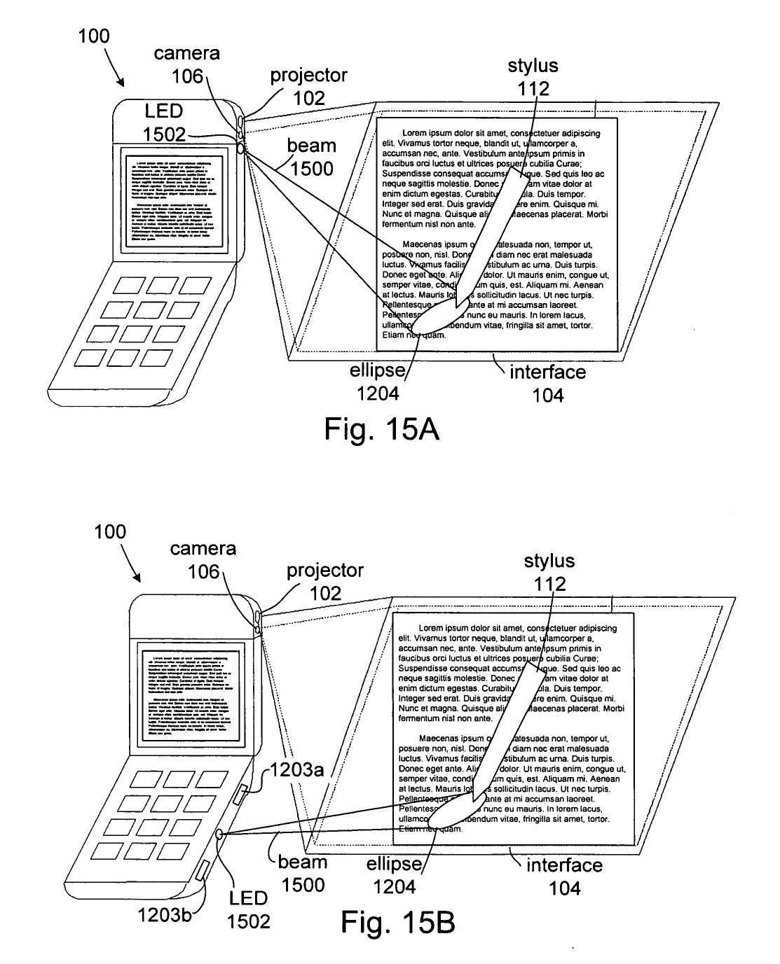

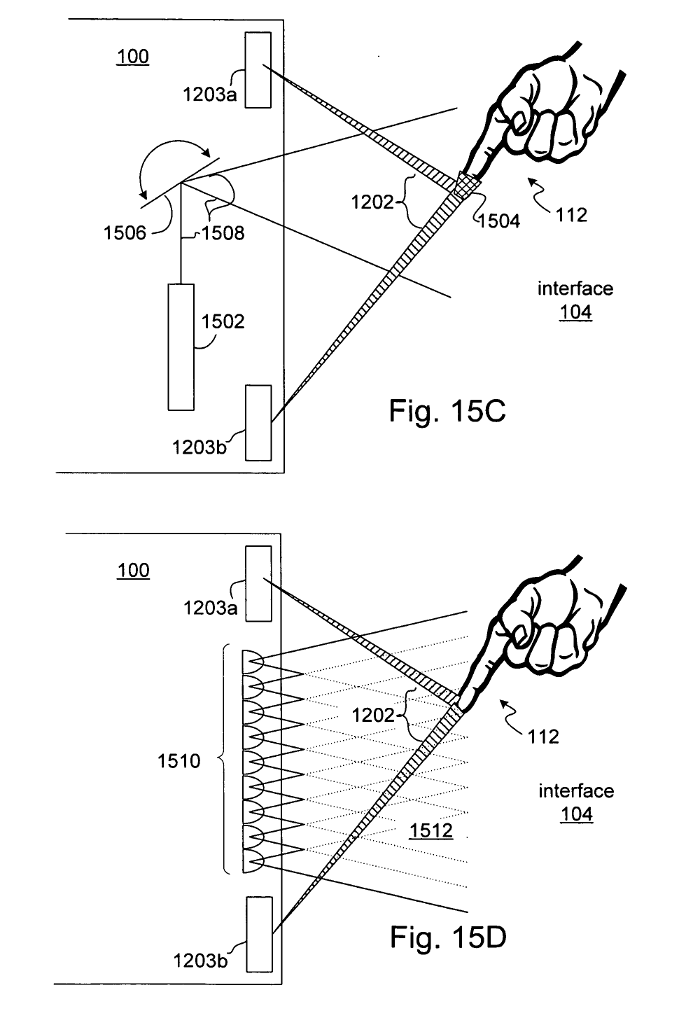

In some examples, as shown in FIGS. 12C and 12D, to keep the beam 1200 directed on the pointing device 112 as the pointing device is moved, the beam is configured to shine a small ellipse 1204 centered on the last-known position of the pointing device 112. The image from the camera 106 is checked to see whether a reflection was detected. If not, the ellipse 1204 is enlarged until a reflection is detected. Alternatively, when the pointing device 112 moves outside the area of the beam 1200, the projector or another light source, as shown in FIG. 15, discussed below, is used to illuminate the entire area of the interface 104 in order to locate the writing instrument. Once the new location is determined, the focused beam 1200 is again used, for increased accuracy of the measured position. Illuminating the entire display area only when the pointing device 112 was not found at its last-known location can save power over continuously illuminating the entire display area.

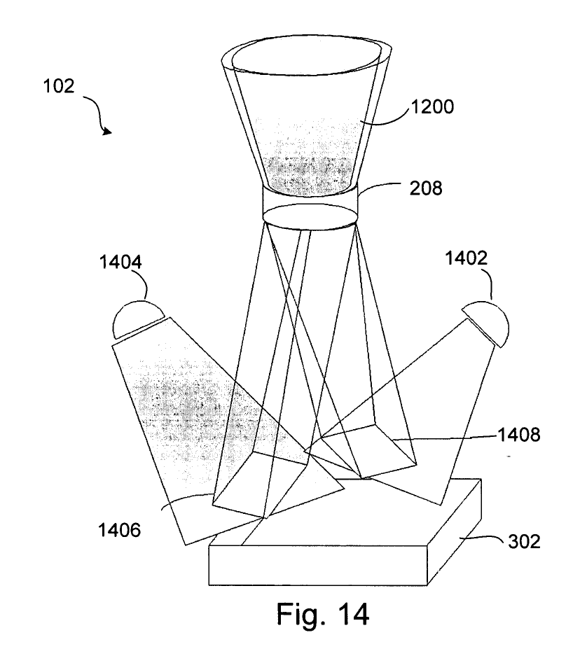

In some examples, the pointing device simply reflects the light used to project the interface 104, without requiring the light to be directed specifically onto the pointing device. This is simplified if the pointing device can reflect the projected light in a manner that the camera can distinguish from the rest of the projected image. One way to do this, as shown in FIG. 13, is to interleave or overlay a projected image 104 with the illumination beam 1200. In some examples, the illumination beam provides infrared illumination which the stylus is specially equipped to reflect. In some examples, as shown in FIG. 14, this can be facilitated by configuring the projector 102 to multiplex between two light sources one for the computer display and one infrared, rather than projecting both at once. To interleave frames, the imaging component 302 of the projector alternates between reflecting light from a visible light source 1402 to generate the interface 104 and directing the light from an infrared light source 1404 to form beam 1200. To project the interface 104 and the beam 1200 simultaneously, a micro-mirror device could be used, in which a subset 1406 of the mirrors (only one mirror shown), not needed for the current image for the interface 104, are used to direct the beam 1200 while the rest of the mirrors 1408 form the image of the interface 104. In some examples, a subset of the mirrors could be specially configured to reflect infrared light and dedicated to that purpose. During an illumination frame, the camera would look in the infrared spectrum for the single bright spot created by the reflection, rather than also looking for added objects or distortions to the projected image in the visible spectrum as described above. During regular frames, the camera would look at the projected image in the visible spectrum as before.

If the interface 104 and beam 1200 are projected simultaneously, an infrared shutter can be used to modulate the camera between detecting the infrared light reflected by the writing instrument 112 and the visible light of the interface 104. Alternatively, two cameras could be used. If the interface 104 and the beam 1200 are projected in alternating frames, visible light from a single light source could be used for both.

In some examples, as shown in FIG. 15A, a second projector or a separate LED or other light source 1502 can be used to project light 1500 onto the page for reflection by the pointing device 112. Such a light source could use the same or different technology as the projector 102 to aim and focus the beam 1500. In such a case, the writing instrument 112 may be completely passive if the IR light source 1502 is located next to the camera 106. A reflective surface is provided near or at the tip of the writing instrument 112. The camera 106 detects the reflection of infrared light 1500 from the tip of the writing instrument 112, and the processor determines the position of the writing instrument 112 as before.

In some examples, dedicated sensors 1203a, b may be used for detecting the position of the pointing device 112, as discussed above. In such cases, the light source 1502 may be positioned near those sensors, as shown in FIG. 15B. The light source 1502 may be designed specifically to work with a finger as the pointing device, for example, to accommodate the complicated reflections that may be produced by a fingernail. In some examples, as shown in FIG. 15C, a reflective attachment 1504, such as a thimble or ring, may be used to increase the amount of light reflected by a finger. In some examples, also shown in FIG. 15C, a galvanometer 1506 or other movable mirror is used to sweep a laser beam 1508 over the area of the interface 104, producing the reflections used by the sensors 1203a, b to locate the pointing device 112. In some examples, as shown in FIG. 15D, a row 1510 of LEDs is used to collectively generate a field 1512 of light. Lenses (not shown) may be used to concentrate the light field 1512 into a plane parallel to that of the projected interface 104. These options may used in various combinations, for example, the attachment 1504 may be useful in combination with the single illuminating LED 1502.

In some examples, the tip of the writing instrument 112 is reflective only when pressed against the surface where the projection is directed. Otherwise, the processor may be unable to distinguish intended input by the writing instrument from movement from place to place not intended as input. This can also allow the user to “click” on user interface elements to indicate that he wishes to select them.

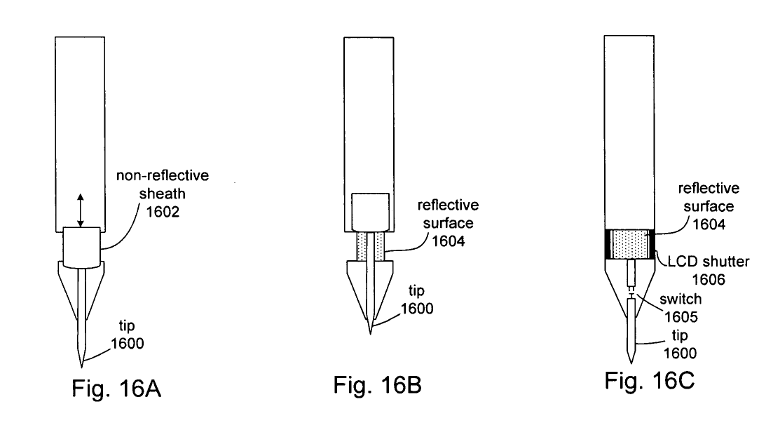

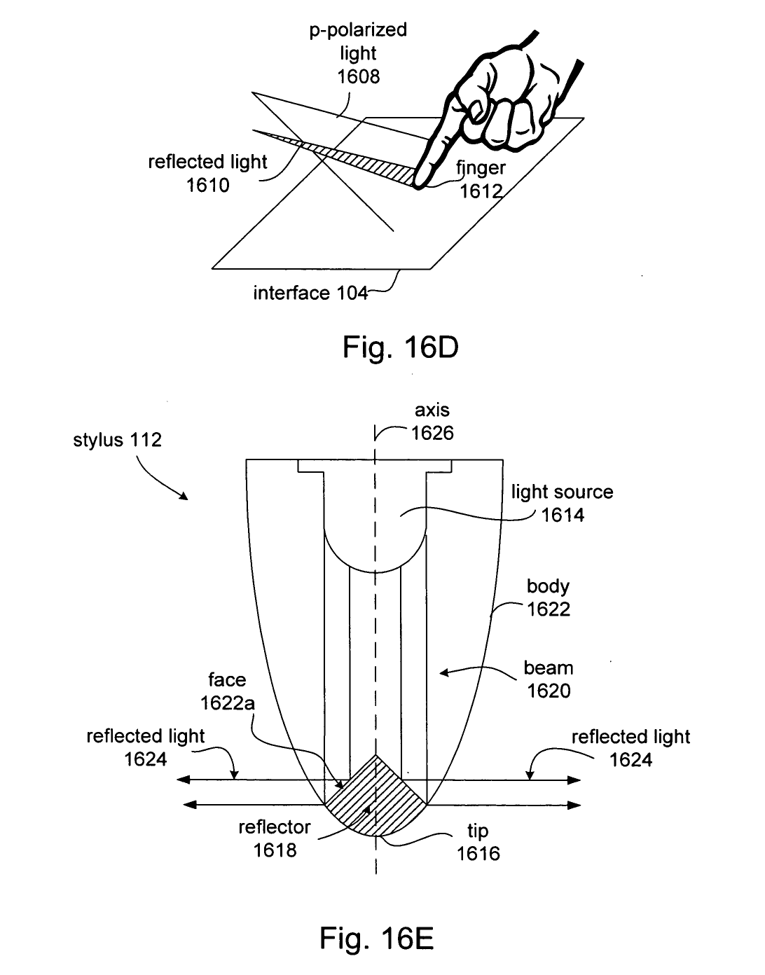

Activation of the reflective mechanism can be mechanical or electrical. In some examples, in a mechanical implementation, as shown in FIGS. 16A and 16B, pressure on the tip 1600 opens up a sheath 1602 and exposes a reflective surface 1604 around the tip. In an electrical implementation, as shown in FIG. 16C, pressure on the tip 1600 closes a switch 1605 that activates liquid crystals 1606 or similar technology that controls whether the reflective surface 1604 is exposed to light. The electrical signal from the switch 1605 may also be used to enable other features, for example, it may trigger, an RF or IR transmitter in the stylus to transmit a signal to the device 100. This signal could be used to indicate a “click” on a user interface element, or to turn the light source in the device 100 on only when the tip 1600 is depressed. Although a stylus is shown in FIGS. 16A-C, the pointing device could be a pen, for example, by replacing the tip 1600 with a ball-point inking mechanism (not shown).

Reflection from other objects, like passive styluses, regular pens, fingers, and rings can be handled, for example, by using p-polarized infrared light 1608 that is reflected (1610) by upright objects like a finger 1612 but not flat surfaces, as shown in FIG. 16D.

In some examples, the writing instrument can actively emit light. A design for such a stylus is shown in FIG. 16E. A light source 1614, such as a collimated or slightly divergent laser beam or an LED, emits a beam of light toward the tip 1616 of the stylus 112. At the tip 1616, a reflector 1618 in a translucent stylus body 1622 is positioned within the path of the beam 1620 and reflects the light outward (reflected light 1624). The internal face 1622a of the body 1622 also contributes to the reflection of the light 1620. The reflector 1618 could be a cone, as illustrated, or could have convex or concave faces, depending on the desired pattern of the reflected light 1624. For example, the reflector 1618 may be configured to reflect the light from the light source 1614 such that it is perpendicular to the axis 1626 of the stylus, or it may be configured to reflect the light at a particular angle, or to diverge the light into multiple angles. If the light beam 1620 is slightly divergent, a flat (in cross section) reflector 1618 will result in reflected light 1624 that continues to diverge, allowing it to be detected from a wide range of positions independent of the tilt of the stylus 112.

In other examples, holographic keyboards can be used for input. (Despite the name, “holographic” keyboards do not necessarily use holograms, though some do.) Several stand-alone holographic keyboards are known and may be commercially available, for example that shown in U.S. Pat. No. 6,614,422, and their functionality can be duplicated by using the projector to project a keyboard in addition to the rest of the user interface, as shown in FIG. 6C, and using the camera 106 to detect which keys the user has pressed. In some examples, the processor uses the image captured by the camera 106 to determine the coordinates of points where the user's fingers or another pointing device touch the projected keyboard and uses a lookup table to determine which projected keys 606 have corresponding coordinates.

The portable computing device can be operated in a number of modes. These include a fully enabled common display mode of a tablet PC computer (most conveniently used when placed on a flat surface, i.e., a table) or a more power-efficient tablet PC mode with “stripped down” versions of PC applications, as described below. An input-only, camera scanning, mode allows the user to input typed text or any other materials for scanning and digital reconstruction (e.g., by OCR) for further use in the digital domain. The camera can be used along with a pen/stylus input for editing materials or just taking handwritten notes, without projecting an image. This may be a more power-efficient approach for inputting handwritten data that can be integrated into any software application later on.

Various combinations of modes can be used depending on the needs of the user and the power requirements of the device. Projecting the user interface and illuminating a pointing device may both require more power than passively tracking the motion of a light-emitting pointing device, so in conditions where power conservation is needed, the device could stop projecting the user interface while the user is writing, and use only the camera or linear sensors to track the motion of the pointing device. Such a power-saving mode could be entered automatically based upon the manner in which the device is being used and user preferences, or entered upon the explicit instruction of the user.

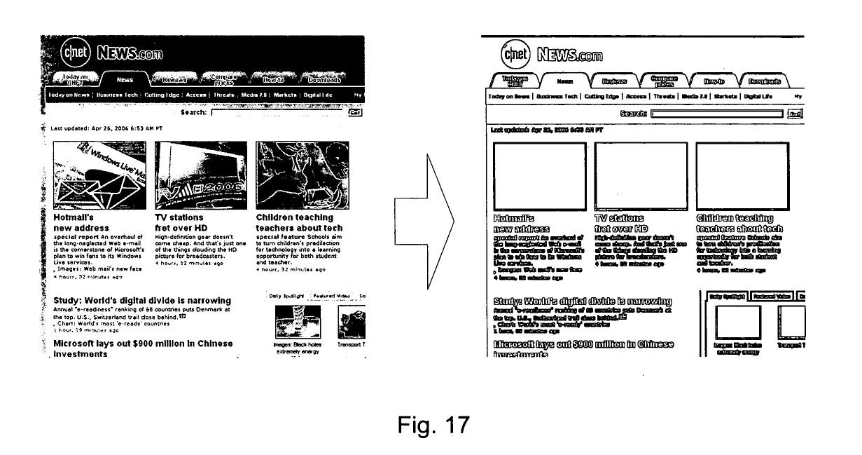

When the user stops writing or otherwise indicates that they want the display back, the device will resume projecting the entire user interface, for example, to allow the user to choose what to do with a file created from the writing they just completed. As an alternative to stopping projecting the user interface entirely, a reduced version of the interface may be projected, for example, showing only text and the borders of images, or removing all non-text elements of a web page, as shown in FIG. 17, or significantly reducing the contrast or saturation or other visible feature of the projected image. Such a mode is especially suited to a vector-based projection, as discussed with reference to FIG. 3B, above. Such a projector directs a single beam of light to draw discreet lines and curves only where they are needed without scanning over the entire projection area. Without the need to illuminate the entire projection area, much less power may be required. In such a mode, power consumption could be further reduced by projecting only a single color, depending on the design of the projector. Storing the interface within the device in vector form can reduce the amount of data required for storage and communication of the image. This may be useful in examples where the device is used as an interface to a remote computer, allowing a smaller-bandwidth communication channel to communicate the entire vector-based user interface. Likewise, the user's input using the pointing device can be represented and communicated in vector form, providing similar advantages.

In some examples, a combination of two linear sensors with a 2-D camera can create capabilities for a 3-D input device and thus enable control of 3-D objects, which are expected to be increasingly common in computer software in the near future, as disclosed in pending patent application Ser. No. 10/623,284.

Vendors of digital sensors produce small power-saving sensors and sensors along with the image processing circuitry that can be used in such applications. Positioning of a light spot in three dimensions is possible using two 2-D photo arrays. Projection of a point of light onto two planes defines a single point in 3-D space. When a sequence of 3-D positions is available, motion of a pointer can control a 3-D object on a PC screen or the projected interface 104. When the pointer moves in space, it can drag or rotate the 3-D object in any direction.

The combination of the projector, camera, and processor in a single unit to simultaneously project a user interface, detect interaction with that interface (including illuminating the pointing device and scanning documents), and update the user interface in reaction to the input, all using optical components, provides advantages. A user need only carry a single device to provide access to a full-sized representation of their files and enable them to interact with their computer through such conventional modes as writing, drawing, and typing. Such an integrated device can provide the capabilities of a high-resolution touch screen without the extra hardware such systems have previously required. At the same time, since the device can have the traditional form of a compact computing device such as a cellular telephone or PDA, the user can use the built-in keyboard and screen for quick inputs and make a smooth transition from the familiar interface to the new one. When they need a larger interface, an enlarged screen, input area, or both, are available without having to switch to a separate device.

Other embodiments are within the scope of the following claims. For example, while a cellular telephone has been used in the figures, any device could be used to house the camera, projector, and related electronics, such as a PDA, laptop computer, or portable music player. The device could be built without a built-in screen or keypad, or could have a touch-screen interface. Although the device discussed in the examples above has the projector, camera, and processor mounted together in the same housing, in some examples, the projector, the camera, or both could be temporarily detachable from the housing, either alone or together. In some examples discussed earlier, a module housing the camera and the projector could be rotatable; other ways to permit the camera or the projector or both to be movable relative to one another with respect to the housing are also possible.

What is claimed is:

1. A method comprising
projecting a display,
optically capturing information representing an image of the projected display and at least a portion of a pointing device in a vicinity of the projected display, and
updating the display based on the captured image information.

2. The method of claim 1 in which the pointing device comprises a finger.

3. The method of claim 1 in which the pointing device comprises a stylus.

4. The method of claim 1 in which the image of the pointing device includes information about whether the pointing device is activated.

5. The method of claim 1 in which the image of the portion of the pointing device comprises light emitted by the pointing device.

6. The method of claim 5 also comprising emitting light from the pointing device based on light from the projector.

7. The method of claim 6 in which the light is emitted from the pointing device asynchronously with the light emitted by the projector.

8. The method of claim 7 in which the image of the pointing device is captured when the pointing device is emitting light and the image of the display is captured when the projector is emitting light.

9. The method of claim 1 also comprising blocking visible light and transmitting infrared light.

10. The method of claim 1 in which the image of the portion of the pointing device comprises light reflected by the pointing device.

11. The method of claim 10 also comprising illuminating the pointing device.

12. The method of claim 11 also comprising projecting the display and illuminating the pointing device in alternating frames.

13. The method of claim 11 also comprising directing light into an ellipse around a previous location of the pointing device, and enlarging the ellipse until the captured image includes light reflected by the pointing device.

14. The method of claim 11 in which illuminating the pointing device comprises energizing a light source when a signal indicates that the pointing device is in use.

15. The method of claim 1 in which projecting the display comprises reflecting light with a micromirror device.

16. The method of claim 1 in which projecting the display comprises reflecting infrared light.

17. The method of claim 16 in which
projecting the display comprises projecting an image with a first subset of micromirrors of the micromirror device,
the method also comprising directing light in a common direction with a second subset of micromirrors of the micromirror device.

18. The method of claim 7 in which the first subset of micromirrors reflect visible light, and the second subset reflect infrared light.

19. The method of claim 1 in which capturing information representing an image of at least a portion the pointing device comprises capturing movement of the pointing device.

20. The method of claim 19 in which the movement of the pointing device comprises handwriting.

21. The method of claim 19 in which updating the display comprises one or more of
creating, modifying, moving, or deleting a user interface element based on movement of the pointing device,
editing text in an interface element based on movement of the pointing device, and
drawing lines based on movement of the pointing device.

22. The method of claim 19 in which the display is projected within a field of view, and updating the display comprises changing the field of view based on movement of the pointing device.

23. The method of claim 19 also comprising
interpreting the movement of the pointing device as selection of a hyperlink in the display, and
updating the display to display information corresponding to the hyperlink.

24. The method of claim 19 also comprising
interpreting the movement of the pointing device as an identification of another device, and
initiating a communication with the other device based on the identification.

25. The method of claim 24 in which initiating the communication comprises placing a telephone call.

26. The method of claim 24 in which initiating the communication comprises
assembling handwriting into a text message, and
transmitting the text message.

27. The method of claim 24 in which initiating the communication comprises
assembling handwriting into an email message, and
transmitting the email message.

28. The method of claim 1 in which
projecting a display comprises projecting an output image and projecting an image of a set of user interface elements, and
capturing the image information includes identifying which projected user interface elements the pointing device is in the vicinity of.

29. The method of claim 28 in which the image of a set of user interface element s comprises an image of a keyboard.

30. The method of claim 1 in which updating the display comprises adjusting the shape of the display to compensate for distortion found in the captured image of the display.

31. The method of claim 1 in which updating the display comprises repeatedly determining an angle to a surface based on the captured information representing an image of the display, and adjusting the shape of the display based on the angle.

32. The method of claim 31 in which projecting the display includes projecting reference marks and determining an angle includes determining distortion of the reference marks.

33. The method of claim 1 in which updating the display comprises adjusting the display to appear undistorted when projected at a known angle.

34. The method of claim 33 in which the known angle is based on an angle between a projecting element and a base surface of a device housing the projecting element.

35. The method of claim 1 in which projecting the display comprises altering a shape of the projected display based on calibration parameters stored in a memory.

36. The method of claim 1 also comprising capturing an image of a surface.

37. The method of claim 36 also comprising creating a file system object representing the image of the surface.

38. The method of claim 37 also comprising recognizing the image of the surface as a photograph, and in which the file system object is an image file representing the photograph.

39. The method of claim 37 also comprising recognizing the image of the surface as an image of a writing, and in which the file system object is a text file representing the writing.

40. The method of claim 1 also comprising
capturing information representing movement of the pointing device, and
editing a file system object based on movement of the pointing device.

41. The method of claim 40 in which editing comprises adding, deleting, moving, or modifying text.

42. The method of claim 40 in which editing comprises adding, deleting, moving, or modifying graphical elements.

43. The method of claim 40 in which editing comprises adding a signature.

44. The method of claim 1 in which the display comprises a computer screen bitmap image.

45. The method of claim 1 in which the display comprises a vector-graphical image.

46. The method of claim 45 in which the vector-graphical image is monochrome.

47. The method of claim 45 in which the vector-graphical image comprises multiple colors.

48. The method of claim 45 in which projecting the display comprises reflecting light along a sequence of line segments using at least a subset of micromirrors of a micromirror device.

49. The method of claim 1 also comprising
generating the display by removing content from an image, and
in which projecting the display comprises projecting the remaining content.

50. The method of claim 48 in which removing content from an image comprises removing image elements composed of bitmaps.

51. The method of claim 1 in which projecting the display comprises projecting a representation of items each having unique coordinates,
the method also comprising
detecting a location touched by the pointing device, and
correlating the location to at least one of the projected items.

52. The method of claim 1 also comprising
transmitting the captured information representing images to a server,
receiving a portion of an updated display from the server, and
in which updating the display comprises adding the received portions of an updated display to the projected display.

53. An apparatus comprising
a projector,
a camera, and
a processor programmed to
receive input from the camera including an image of a projected interface and a pointing device,
generate an interface based on the input, and
use the projector to project the interface.

54. The apparatus of claim 53 in which the projector has a first field of view, the camera has a second field of view, and the first and second fields of view at least partially overlap.

55. The apparatus of claim 53 in which the projector has a first field of view, the camera has a second field of view, and the first and second fields of view do not overlap.

56. The apparatus of claim 53 in which the projector has a first field of view, the camera has a second field of view, and at least one of the first and second fields of view can be repositioned.

57. The apparatus of claim 53 in which the projector and the camera can be repositioned relative to the rest of the apparatus.

58. The apparatus of claim 53 in which the camera comprises a filter that blocks visible light and admits infrared light.

59. The apparatus of claim 53 also comprising a source of light positioned to illuminate the pointing device.

60. The apparatus of claim 53 also comprising a sensor positioned to receive light from the pointing device.

61. The apparatus of claim 53 in which the projector comprises a micromirror device.

62. The apparatus of claim 60 in which a subset of micromirrors of the micromirror device are adapted to reflect infrared light.

63. The apparatus of claim 53 also comprising wireless communications circuitry.

64. The apparatus of claim 53 also comprising a memory storing a set of instructions for the processor.

65. An apparatus comprising
a projector having a first field of view,
a camera having a second field of view, the first and second fields of view not overlapping,
wireless communications circuitry, and
a processor programmed to
receive input from the camera including an image of a projected interface and a pointing device,
generate an interface based on the input, and
use the projector to project the interface.

66. An apparatus comprising
a light source, and
a cone-shaped reflector positioned within a path of light from the light source.
